(19) United States
(12) Patent Application Publication
(10) Pub. No.: US 2011/0221788 A1
(43) Pub. Date: Sep. 15, 2011

(54) LIQUID CRYSTAL DISPLAY AND PICTURE DISPLAY SYSTEM

(75) Inventors: Mitsuyasu ASANO, Tokyo (JP); Tomohiro Nishi, Tokyo (JP)

(73) Assignee: Sony Corporation

(21) Appl. No.: 13/016,138

(22) Filed: Jan. 28, 2011

(30) Foreign Application Priority Data
Mar. 9, 2010 (JP) 2010-051979

(51) Int. Cl. G09G 3/36; G09G 5/10

(52) U.S. Cl. 345/690; 345/87

(57) ABSTRACT

A liquid crystal display includes: a light source section including light emission subsections; a liquid crystal display panel modulating, based on an input picture signal, light emitted from each light emission subsection to display pictures through switching of picture streams from one to another in order; and a display control section including a divisional-drive processing section generating a light emission pattern signal for the light emission subsections and a divisional-drive picture signal based on the input picture signal. The display control section performs a light emission drive on the light emission subsection with use of the light emission pattern signal and performs a display drive on the liquid crystal display panel with use of the divisional-drive picture signal. The divisional-drive processing section determines a logical-OR picture of the picture streams, and generates the light emission pattern signal and the divisional-drive picture signal with use of the logical-OR picture.

### BACKGROUND OF THE INVENTION

1. Field of the Invention

The present invention relates to a liquid crystal display including a light source section which includes a plurality of light emission subsections, and a picture display system using such a liquid crystal display and shutter glasses.

2. Description of the Related Art

In recent years, as displays for flat-screen televisions and portable terminals, active matrix liquid crystal displays (LCDs) in which TFTs (Thin Film Transistors) are arranged for respective pixels are often used. In such liquid crystal displays, typically, pixels are individually driven by line-sequentially writing a picture signal to auxiliary capacitance elements and liquid crystal elements of the pixels from the top to the bottom of a screen.

In the liquid crystal displays, depending on applications, a drive (hereinafter referred to as time-division drive) for dividing one frame period into a plurality of periods and displaying different pictures in the respective periods is performed. Examples of a liquid crystal display using such a time-division drive system (frame sequential system) include a stereoscopic picture display system using shutter glasses as described in Japanese Unexamined Patent Application Publication No. 2000-4451.

In the stereoscopic picture display system using the shutter glasses, one frame period is divided into two periods, and two pictures which have a parallax therebetween as a right-eye picture and a left-eye picture are alternately displayed. Moreover, shutter glasses performing an opening/closing operation in synchronization with switching of the pictures are used. The shutter glasses are controlled so that a left-eye lens is opened (a right-eye lens is closed) in a left-eye picture displaying period and the right-eye lens is opened (the left-eye lens is closed) in a right-eye picture displaying period. When a viewer wearing such shutter glasses watches display pictures, stereoscopic vision is achieved.

On the other hand, as backlights used for the liquid crystal displays, backlights using cold cathode fluorescent lamps (CCFLs) as light sources are mainstream; however, in recent years, backlights using light emitting diodes (LEDs) have appeared.

As a liquid crystal display using such an LED or the like as a backlight, as described in Japanese Unexamined Patent Application Publication No. 2001-142409, there is proposed a liquid crystal display including a light source section which is divided into a plurality of light emission subsections so that the light emission subsections perform an light emission operation separately from one another (perform a divisional light emission operation).

### SUMMARY OF THE INVENTION

However, in the case where a divisional light emission operation of a backlight in related art is applied as-is to the above-described time-division drive stereoscopic picture display system, it is considered that the following issue arises, because a right-eye picture and a left-eye picture which are alternately displayed have a parallax therebetween.

A difference in the position of an object arises between a right picture and a left picture to cause a difference in a light emission pattern of a backlight between when a right-eye picture is displayed and when a left-eye picture is displayed. More specifically, a light emission subsection in which light emission intensity differs between when a right picture is displayed and when a left picture is displayed exists, and in extreme cases, the light emission subsection may emit light when one of the pictures is displayed, and may not emit light when the other picture is displayed.

When a change (a temporal change) in light emission luminance occurs between the right and left pictures, the change greatly affects a region which has no parallax and is supposed to have constant light emission luminance; therefore, it is difficult to solve the issue by control of transmittance in a liquid crystal display panel. As a result, in the case where the divisional light emission operation of the backlight in related art is applied as-is to the time-division drive stereoscopic picture display system, the generation of flickers is increased to cause a decline in display image quality.

Moreover, to prevent such a temporal change in light emission luminance between the right and left pictures, for example, it is considered to arrange a filter in a temporal axis direction; however, in this case, the following issue arises. When light emission luminance is leveled out with use of the filter, the light emission luminance is set to an intermediate light emission luminance level between the light emission luminance levels of the right and left pictures when the right picture is displayed and when the left picture is displayed to thereby cause a decline in light emission luminance, compared to an original level; therefore it is difficult to secure display luminance.

The above-described issues occur not only in the stereoscopic picture display system but also a typical display system displaying pictures through performing time-divisional switching of a plurality of picture streams from one to another in order. Therefore, it is desirable to propose a technique for improving display image quality when displaying pictures through performing time-divisional switching of a plurality of picture streams from one to another in order with use of a light source performing a divisional light emission operation.

It is desirable to provide a liquid crystal display allowed to improve display image quality when displaying pictures through performing time-divisional switching of a plurality of picture streams from one to another in order with use of a light source performing a divisional light emission operation, and a picture display system using such a liquid crystal display.

According to an embodiment of the invention, there is provided a liquid crystal display including: a light source section including a plurality of light emission subsections which are controlled separately from one another; a liquid crystal display panel modulating, based on an input picture signal, light emitted from each of the light emission subsections of the light source section to display pictures through performing time-divisional switching of a plurality of picture streams from one to another in order; and a display control section including a divisional-drive processing section which generates a light emission pattern signal and a divisional-drive picture signal based on the input picture signal, the light emission pattern signal representing a light emission pattern for each of the light emission subsections of the light source section, the display control section performing a light emission drive on each of the light emission subsections of the light source section with use of the light emission pattern signal and performing a display drive on the liquid crystal display panel with use of the divisional-drive picture signal. The divisional-drive processing section determines, based on the input picture signal, a logical-OR picture which is a logical-OR of pictures each belonging to the plurality of picture streams, and generates the light emission pattern signal and the divisional-drive picture signal with use of the logical-OR picture.

According to an embodiment of the invention, there is provided a picture display system including: the liquid crystal display according to the embodiment of the invention; and shutter glasses performing an opening/closing operation in synchronization with switching of the plurality of pictures in the liquid crystal display.

In the liquid crystal display and the picture display system according to the embodiment of the invention, based on the input picture signal, the light emission pattern signal representing the light emission pattern for each of the light emission subsections of the light source section and the divisional-drive picture signal are generated. Then, a light emission drive on each of the light emission subsections of the light source section is performed with use of the light emission pattern signal, and a display drive on the liquid crystal display panel is performed with use of the divisional-drive picture signal. At this time, based on the above-described input picture signal, a logical-OR picture which is a logical-OR of pictures each belonging to the plurality of picture streams is determined, and the above-described light emission pattern signal and the above-described divisional-drive picture signal are generated with use of the logical-OR picture. Therefore, unlike the case where a light emission drive and a display drive are performed with use of light emission pattern signals generated for a plurality of pictures which are different from one another, respectively, a change (a temporal change) in light emission luminance (display luminance) among the plurality of pictures is prevented to reduce the generation of flickers. Moreover, the above-described logical-OR picture is determined as a logical-OR of pictures each belonging to the plurality of picture streams; therefore, unlike the case where, for example, a filter for leveling out the light emission pattern signal and the divisional-drive picture signal along a temporal axis direction is used, display luminance does not decline.

In the liquid crystal display and the picture display system according to the embodiment of the invention, the logical-OR picture is determined as a logical-OR of the pictures each belonging to the plurality of picture streams, and the light emission pattern signal and the divisional-drive picture signal are generated with use of the logical-OR picture; therefore, without reducing display luminance (while maintaining display luminance), the generation of flickers is allowed to be reduced. Therefore, when the plurality of pictures are displayed in a time divisional manner with use of a light source performing a divisional light emission operation, display image quality is allowed to be improved.

Other and further objects, features and advantages of the invention will appear more fully from the following description.

### BRIEF DESCRIPTION OF THE DRAWINGS

FIG. 1 is a block diagram illustrating a whole configuration of a picture display system according to an embodiment of the invention.

FIG. 2 is a circuit diagram illustrating a specific configuration example of a pixel illustrated in FIG. 1.

FIG. 3 is a schematic exploded perspective view illustrating an example of a light emission sub-region and a divisional irradiated region in a liquid crystal display illustrated in FIG. 1.

FIG. 4 is a block diagram illustrating a specific configuration of a divisional-drive processing section illustrated in FIG. 1.

FIG. 5 is a schematic view illustrating a divisional light emission operation of a backlight in the liquid crystal display illustrated in FIG. 1.

FIGS. 6A and 6B are schematic views illustrating a stereoscopic picture display operation in the picture display system illustrated in FIG. 1.

FIG. 7 is a block diagram illustrating a configuration of a divisional-drive processing section in a liquid crystal display according to a comparative example.

FIGS. 8A and 8B are schematic views illustrating an example of a left-eye picture signal and a right-eye picture signal to be supplied.

FIG. 9 is a timing chart illustrating an example of a divisional light emission operation in the liquid crystal display according to the comparative example.

FIG. 10 is a schematic view illustrating an example of an operation of a logical-OR picture generation section illustrated in FIG. 4.

FIG. 11 is a timing chart illustrating an example of a divisional light emission operation in the liquid crystal display according to the embodiment.

FIG. 12 is a block diagram illustrating a configuration of a divisional-drive processing section according to Modification 1 of the invention.

FIGS. 13A and 13B are schematic views illustrating a multiple picture display operation in a picture display system according to Modification 2 of the invention.

### DETAILED DESCRIPTION OF THE PREFERRED EMBODIMENTS

A preferred embodiment of the invention will be described in detail below referring to the accompanying drawings. Descriptions will be given in the following order.

1. Embodiment (Example 1 of applying the invention to stereoscopic picture display system)

### 2. Modifications

Modification 1 (Example 2 of applying the invention to stereoscopic picture display system)
Modification 2 (Example of applying the invention to a multiple picture display system)

### Embodiment

### Whole Configuration of Picture Display System

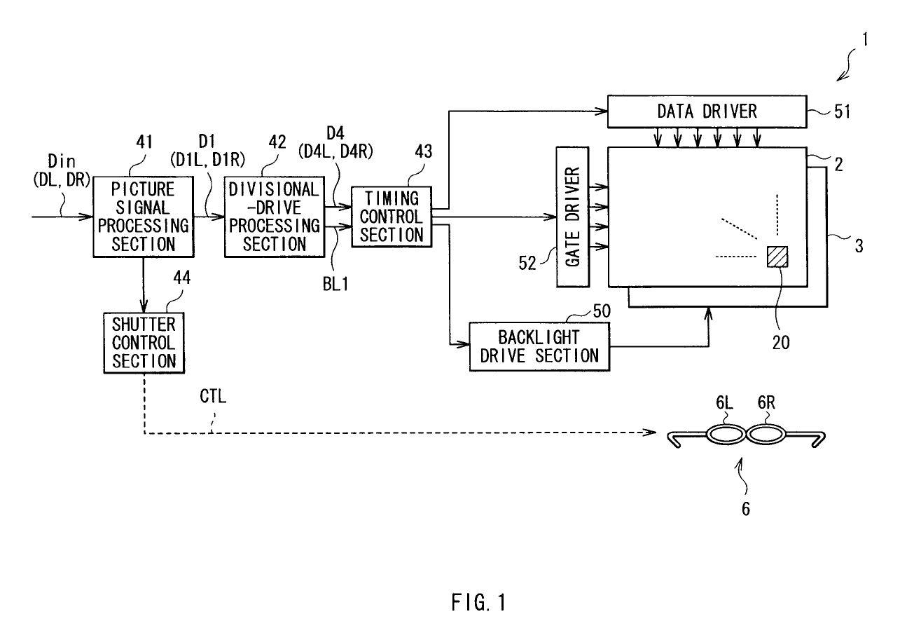

FIG. 1 illustrates a block diagram of a whole picture display system according to an embodiment of the invention. The picture display system is a time-division drive stereoscopic picture display system, and includes a liquid crystal display 1 as a picture display and shutter glasses 6.

Liquid Crystal Display 1

The liquid crystal display 1 displays a picture based on an input picture signal Din including a right-eye picture signal DR and a left-eye picture signal DL which have a binocular parallax. The liquid crystal display 1 includes a liquid crystal display panel 2, a backlight 3 (a light source section), a picture signal processing section 41, a divisional-drive processing section 42, a timing control section 43, a shutter control section 44, a backlight drive section 50, a data driver 51 and a gate driver 52. The picture signal processing section 41, the divisional-drive processing section 42, the timing control section 43, the shutter control section 44, the backlight drive section 50, the data driver 51 and the gate driver 52 correspond to a specific example of “a display control section” in the invention.

The liquid crystal display panel 2 modulates light emitted from the backlight 3 which will be described later based on the input picture signal Din so as to display a picture based on the input picture signal Din. More specifically, as will be described in detail later, a right-eye picture based on the right-eye picture signal DR and a left-eye picture based on the left-eye picture signal DL are alternately displayed through performing time-divisional switching of a plurality of picture streams from one to another in order. In other words, in the liquid crystal display panel 2, pictures are displayed in output order controlled by the picture signal processing section 41 which will be described later to perform a time division drive for stereoscopic picture display. The liquid crystal display panel 2 includes a plurality of pixels 20 arranged in a matrix form as a whole.

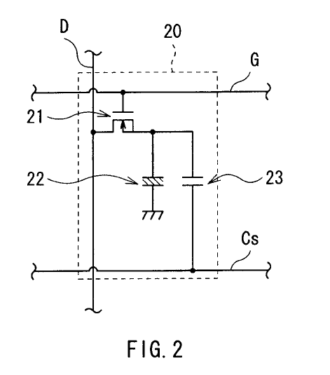

FIG. 2 illustrates a circuit configuration example of a pixel circuit in each pixel 20. The pixel 20 includes a liquid crystal element 22, a TFT element 21 and an auxiliary capacitance element 23. A gate line G for line-sequentially selecting a pixel to be driven, a data line D for supplying a picture voltage (a picture voltage supplied from the data driver 51) to the pixel to be driven and an auxiliary capacitance line Cs are connected to the pixel 20.

The liquid crystal element 22 performs a display operation in response to a picture voltage supplied from the data line D to one end thereof through the TFT element 21. The liquid crystal element 22 is configured by sandwiching a liquid crystal layer (not illustrated) made of, for example, a VA (Vertical Alignment) mode or TN (Twisted Nematic) mode liquid crystal between a pair of electrodes (not illustrated). One (one end) of the pair of electrodes in the liquid crystal element 22 is connected to a drain of the TFT element 21 and one end of the auxiliary capacitance element 23, and the other (the other end) of the pair of electrodes is grounded. The auxiliary capacitance element 23 is a capacitance element for stabilizing an accumulated charge of the liquid crystal element 22. One end of the auxiliary capacitance element 23 is connected to the one end of the liquid crystal element 22 and the drain of the TFT element 21, and the other end of the auxiliary capacitance element 23 is connected to the auxiliary capacitance line Cs. The TFT element 21 is a switching element for supplying a picture voltage based on a picture signal D1 to the one end of the liquid crystal element 22 and the one end of the auxiliary capacitance element 23, and is configured of a MOS-FET (Metal Oxide Semiconductor-Field Effect Transistor). A gate and a source of the TFT element 21 are connected to the gate line G and the data line D, respectively, and the drain of the TFT element 21 is connected to the one end of the liquid crystal element 22 and the one end of the auxiliary capacitance element 23.

The backlight 3 is a light source section applying light to the liquid crystal display panel 2, and includes, for example, a CCFL (Cold Cathode Fluorescent Lamp), an LED (Light Emitting Diode) or the like as a light-emitting element. As will be described later, the backlight 3 performs a light emission drive according to information (a picture pattern) of the input picture signal Din.

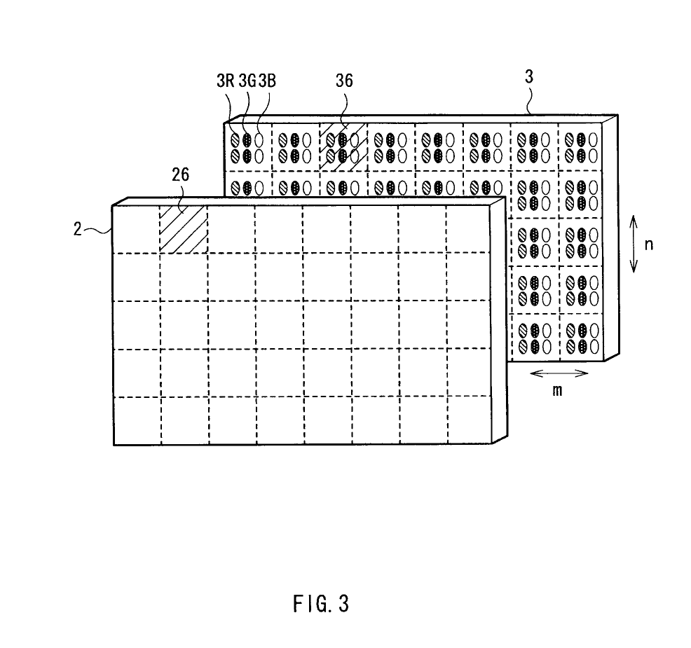

For example, as illustrated in FIG. 3, the backlight 3 includes a plurality of light emission sub-regions 36 (light emission subsections) which are controlled separately from one another. In other words, the backlight 3 is configured of a divisional-drive system backlight. More specifically, the backlight 3 includes a plurality of light emission sub-regions 36 by two-dimensionally arranging a plurality of light sources. Therefore, the backlight 3 is divided into n (vertical)×m (horizontal)=K light emission regions (n and m each are an integer of 2 or more) in an in-plane direction. The number of the light emission regions is lower than the resolution of the pixels 20 in the above-described liquid crystal display panel 2. Moreover, as illustrated in FIG. 3, the liquid crystal display panel 2 includes a plurality of divisional irradiated regions 26 corresponding to the light emission sub-regions 36, respectively.

The backlight 3 is allowed to independently control light emission of the light emission sub-regions 36 based on the information (the picture pattern) of the input picture signal Din. In this case, each of the light sources in the backlight 3 is configured of a combination of a red LED 3R emitting red light, a green LED 3G emitting green light and a blue LED 3B emitting blue light. However, the kind of LED used as the light source is not limited thereto, and, for example, a white LED emitting white light may be used. Note that one or more light sources of such a kind are arranged in each of the light emission sub-regions 36.

The picture signal processing section 41 controls the output order (writing order, display order) of the right-eye picture signal DR and the left-eye picture signal DL based on the input picture signal Din to generate the picture signal D1. In this case, the picture signal D1 configured by alternately arranging the left-eye picture signal D1L and the right-eye picture signal D1R in one frame period is generated. In this case, a period where the left-eye picture in one frame period is displayed and a period where the right-eye picture in one frame period are called “L sub-frame period”, and “R sub-frame period”, respectively. Note that in the picture signal processing section 41, for example, predetermined image processing (such as a sharpness process or a gamma correction process) for an improvement in image quality may be performed.

The shutter control section 44 generates a timing control signal (a control signal CTL) corresponding to output timings of the right-eye picture signal D1R and the left-eye picture signal D1L by the picture signal processing section 41 to send the timing control signal to the shutter glasses 6. Note that in this case, the control signal CTL is a wireless signal such as an infrared signal, but may be a wired signal.

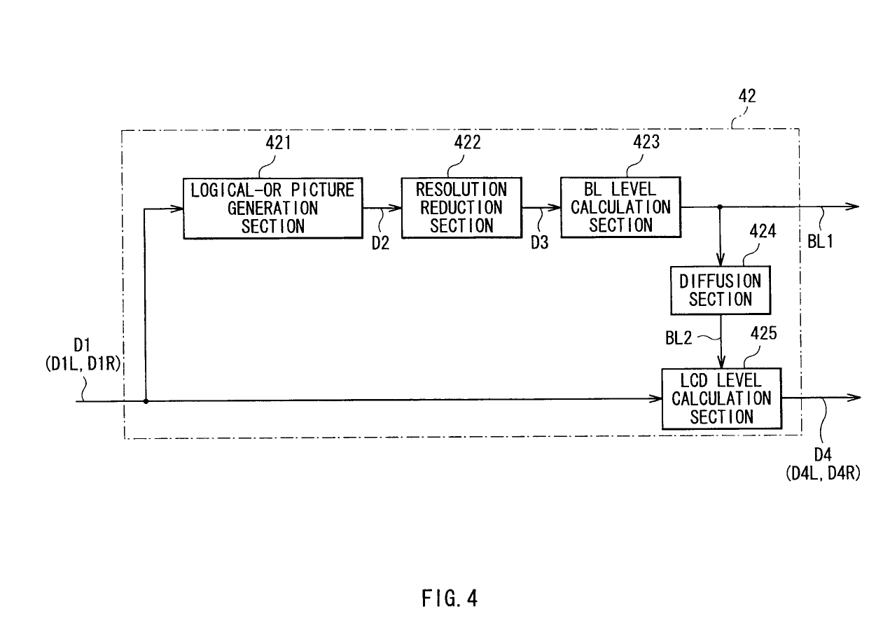

The divisional-drive processing section 42 performs predetermined divisional-drive processing on the picture signal D1 (D1L, D1R) supplied from the picture signal processing section 41. Therefore, a light emission pattern signal BL1 representing a light emission pattern for each light emission sub-region 36 in the backlight 3 and a divisional-drive picture signal D4 configured by alternately arranging a left-eye picture signal D4L and a right-eye picture signal D4R in one frame period are generated. More specifically, in the embodiment, the divisional-drive processing section 42 generates a logical-OR picture (which will be described later) as a logical-OR of the left-eye picture and the right-eye picture, and generates the light emission pattern signal BL1 and the divisional-drive picture signal D4 with use of the logical-OR picture. Note that a specific configuration of the divisional-drive processing section 42 will be described later (refer to FIG. 4).

The timing control section 43 controls drive timings of the backlight driving section 50, the gate driver 52 and the data driver 51, and supplies, to the data driver 51, the divisional-drive picture signal D4 supplied from the divisional-drive processing section 42.

The gate driver 52 line-sequentially drives the pixels 20 in the liquid crystal display panel 2 along the above-described gate line G in response to timing control by the timing control section 43. Therefore, a display drive based on the divisional-drive picture signal D4 is performed on the liquid crystal display panel 2.

The data driver 51 supplies, to each of the pixels 20 of the liquid crystal display panel 2, a picture voltage based on the divisional-drive picture signal D4 supplied from the timing control section 43. More specifically, the data driver 51 performs D/A (digital/analog) conversion on the divisional-drive picture signal D4 to generate a picture signal (the above-described picture voltage) as an analog signal to output the analog signal to each of the pixels 20.

The backlight drive section 50 performs a light emission drive (a lighting drive) on each of the light emission sub-regions 36 in the backlight 3 based on the light emission pattern signal BL1 supplied from the divisional-drive processing section 42 in response to timing control by the timing control section 43.

Shutter Glasses 6

When a viewer (not illustrated in FIG. 1) of the liquid crystal display 1 wears the shutter glasses 6, stereoscopic vision is achievable, and the shutter glasses 6 includes a left-eye lens 6L and a right-eye lens 6R. For example, liquid crystal shutters (light-shielding shutters) using a liquid crystal element (not illustrated) are arranged on the left-eye lens 6L and the right-eye lens 6R, respectively. An effective state (an open state, a transmission state) and an ineffective state (a close state, a shielding state) of a function of shielding incident light in each of the light-shielding shutters are controlled in a time-divisional manner by the control signal CTL supplied from the shutter control section 44.

More specifically, the shutter control section 44 controls the shutter glasses 6 so as to alternately change the open/close states of the left-eye lens 6L and the right-eye lens 6R in synchronization with switching of the left-eye picture and the right-eye picture in the liquid crystal display 1. In other words, in the above-described L sub-frame period, the shutter control section 44 controls the shutter glasses 6 so that the left-eye lens 6L is turned into the open state and the right-eye lens 6R is turned into the close state, and in the R sub-frame period, the shutter control section 44 controls the shutter glasses 6 so that the right-eye lens 6R is turned into the open state and the left-eye lens 6L is turned into the close state. Therefore, in the time divisional drive system alternately displaying the right-eye picture and the left-eye picture by diving one frame period into two periods, the viewer is allowed to watch the right-eye picture with his right eye and the left-eye picture with his left eye.

Specific Configuration of Divisional-Drive Processing Section 42

Next, referring to FIG. 4, a specific configuration of the divisional-drive processing section 42 will be described below. FIG. 4 illustrates a block diagram of the divisional-drive processing section 42. The divisional-drive processing section 42 includes a logical-OR picture generation section 421, a resolution reduction section 422, a BL level calculation section 423, a diffusion section 424 and a LCD level calculation section 425.

The logical-OR picture generation section 421 generates a logical-OR picture as a logical-OR of the left-eye picture and the right-eye picture based on the picture signal D1 configured by alternately arranging the left-eye picture signal D1L and the right-eye picture signal D1R in one frame period. More specifically, the logical-OR picture generation section 421 generates a picture signal D2 configuring such a logical-OR picture by determining a logical-OR of the left-eye picture signal D1L and the right-eye picture signal D1R from one unit region to another (in this case, from one pixel 20 to another pixel 20). The picture signal D2 generated in such a manner is configured by alternately arranging a left-eye picture signal D2L and a right-eye picture signal D2R which are the same picture signal in one frame period. A specific operation of the logical-OR picture generation section 421 will be described later.

The resolution reduction section 422 generates a picture signal D3 as a base of the above-described light emission pattern signal BL1 by performing a predetermined resolution reduction process on the picture signal D2 (D2L, D2R) supplied from the logical-OR picture generation section 421. More specifically, the resolution reduction section 422 reconfigures the picture signal D2 configured of a luminance level signal for each of the pixels 20 into a luminance level signal for each of the light emission sub-regions 36 of which number is lower than the resolution of the pixels 20 so as to generate a picture signal D3.

The BL level calculation section 423 calculates a light emission luminance level in each of the light emission sub-regions 36 based on the picture signal D3 as a luminance level signal for each of the light emission sub-regions 36 to generate the light emission pattern signal BL1 representing a light emission pattern for each of the light emission sub-regions 36. More specifically, a light emission pattern according to the luminance level in each region is obtainable by analyzing the luminance level of the picture signal D3 for each of the light emission sub-regions 36.

The diffusion section 424 performs a predetermined diffusion process on the light emission pattern signal BL1 supplied from the BL level calculation section 423 to output the light emission pattern signal BL2 subjected to the diffusion process to the LCD level calculation section 425, and converts a signal for each of the light emission sub-regions 36 to a signal for each of the pixels 20. The diffusion process is a process performed in consideration of a luminance distribution (a diffusion distribution of light from a light source) in an actual light source (in this case, an LED of each color) in the backlight 3.

The LCD level calculation section 425 generates a divisional-drive picture signal D4 configured by alternately arranging a left-eye picture signal D4L and a right-eye picture signal D4R in one frame period based on the picture signal D1 (D1L, D1R) and the light emission pattern signal BL2 subjected to the diffusion process. Specifically, the signal levels of the left-eye picture signal D1L and the right-eye picture signal D1R are divided by the light emission pattern signal BL2 subjected to the diffusion process to generate the left-eye picture signal D4L and the right-eye picture signal D4R. More specifically, the LCD level calculation section 425 generates the left-eye picture signal D4L and the right-eye picture signal D4R with use of the following expressions (1) and (2).

D4L=(D1L/BL2) (1)

D4R=(D1R/BL2) (2)

A relationship of an original signal (the picture signal D1)=(the light emission pattern signal BL2×the divisional-drive picture signal D4) is obtained by the above-described expressions (1) and (2). In the relationship, (the light emission pattern signal BL2×the divisional-drive picture signal D4) physically means that an image based on the divisional-drive picture signal is superimposed on an image in each light emission sub-region 36 in the backlight 3 emitting light with a certain light emission pattern. Therefore, bright and dark distributions of transmitted light in the liquid crystal display panel 2 are cancelled out, and viewing a picture formed by superimposing the images is equivalent to viewing original display (display based on an original signal).

Functions and Effects of Picture Display System

Next, functions and effects of the picture display system according to the embodiment will be described below.

### 1. Brief Description of Stereoscopic Picture Display Operation and Divisional Light Emission Operation

In the picture display system, as illustrated in FIG. 1, in the liquid crystal display 1, the picture signal processing section 41 performs the control of the output order (writing order, display order) of the right-eye picture signal DR and the left-eye picture signal DL on the input picture signal Din. Therefore, the picture signal D1 configured by alternately arranging the left-eye picture signal D1L and the right-eye picture signal D1R in one frame period is generated. Next, the shutter control section 44 outputs the control signals CTL corresponding to output timings of the right-eye picture signal D1R and the left-eye picture signal D1L to the shutter glasses 6.

Moreover, the picture signal D1 is supplied from the picture signal processing section 41 to the divisional-drive processing section 42. The divisional-drive processing section 42 performs a predetermined divisional-drive process on the picture signal D1. Therefore, the light emission pattern signal BL1 representing a light emission pattern for each of the light emission sub-regions 36 in the backlight 3 and the divisional-drive picture signal D4 configured by alternately arranging the left-eye picture signal D4L and the right-eye picture signal D4R in one frame period are generated.

Next, the divisional-drive picture signal D4 and the light emission pattern signal BL1 generated in such a manner are entered into the timing control section 43. The divisional-drive picture signal D4 is supplied from the timing control section 43 to the data driver 51. The data driver 51 performs D/A conversion on the divisional-drive picture signal D4 to generate a picture voltage which is an analog signal. Then, a display drive operation is performed by a drive voltage supplied from the gate driver 52 and the data driver 51 to each of the pixels 20. Therefore, a display drive based on the divisional-drive picture signal D4 is performed on the liquid crystal display panel 2.

More specifically, as illustrated in FIG. 2, ON/OFF operations of the TFT element 21 are switched in response to a selection signal supplied from the gate driver 52 through the gate line G. Therefore, conduction is selectively established between the data line D and the liquid crystal element 22 and the auxiliary capacitance element 23. As a result, a picture voltage based on the divisional-drive picture signal D4 supplied from the data driver 51 is supplied to the liquid crystal element 22, and a line-sequential display drive operation is performed.

On the other hand, the light emission pattern signal BL1 is supplied from the timing control section 43 to the backlight drive section 50. The backlight drive section 50 performs a light emission drive (a divisional-drive operation) on the backlight 3 based on the light emission pattern signal BL1.

In the pixels 20 to which the picture voltage is supplied in such a manner, illumination light from the backlight 3 is modulated in the liquid crystal display panel 2 to be emitted as display light. Thus, a picture based on the input picture signal Din is displayed on the liquid crystal display 1.

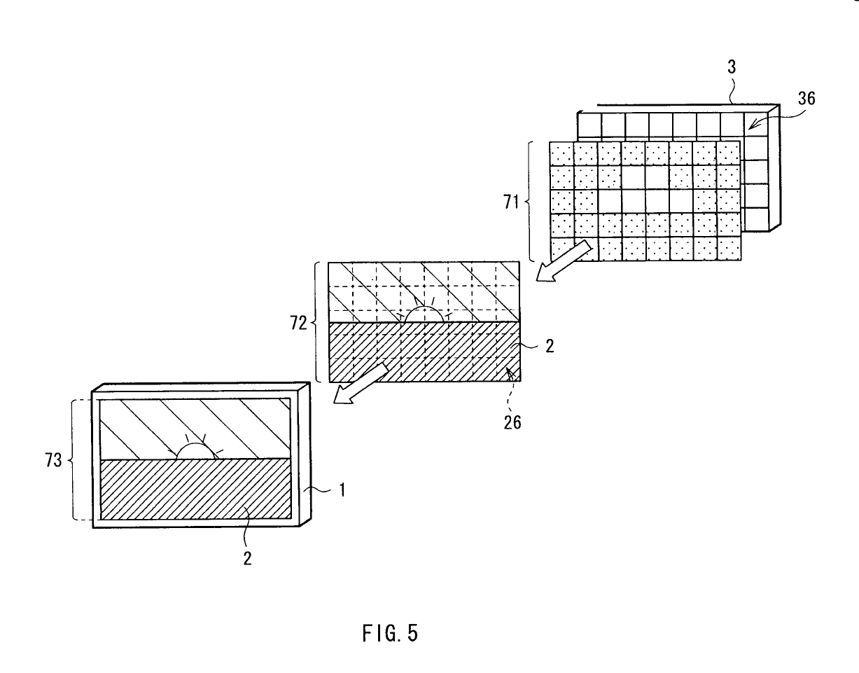

More specifically, for example, as illustrated in FIG. 5, a composite image 73 formed by physically superimposing (multiplicatively combining) a light-emission plane image 71 by each of the light emission sub-regions 36 of the backlight 3 and a panel plane image 72 only by the liquid crystal display panel 2 on each other is a picture eventually viewed on a whole liquid crystal display 1.

Moreover, at this time, in the embodiment, a left-eye picture based on the left-eye picture signal DL and a right-eye picture based on the right-eye picture signal DR are alternately displayed in one frame period to perform a display drive operation by a time division drive.

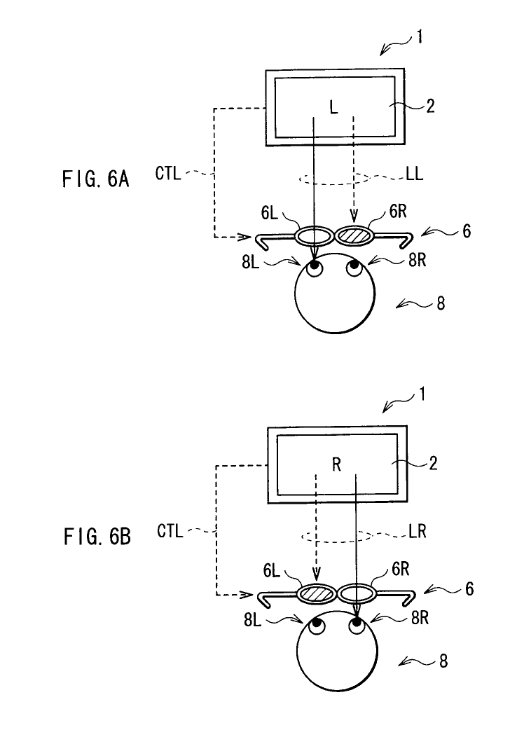

At this time, as illustrated in FIG. 6A, when the left-eye picture L is displayed, in the shutter glasses 6 used by a viewer 8, in response to the control signal CTL, a light-shielding function in the right-eye lens 6R is turned into an effective state, and the light-shielding function in the left-eye lens 6L is turned into an ineffective state. In other words, the left-eye lens 6L is turned into an open state for transmission of display light LL for display of the left-eye picture L, and the right-eye lens 6R is turned into a close state for transmission of the display light LL.

On the other hand, as illustrated in FIG. 6B, when the right-eye picture R is displayed, in response to the control signal CTL, the light-shielding function in the left-eye lens 6L is turned into an effective state, and the light-shielding function in the right-eye lens 6R is turned into an ineffective state. In other words, the right-eye lens 6R is turned into an open state for transmission of display light LR for display of the right-eye picture, and the left-eye lens 6L is turned in a close state for transmission of the display light LR.

Then, such states illustrated in FIGS. 6A and 6B are alternately repeated in a time-divisional manner; therefore, when the viewer 8 wearing the shutter glasses 6 watches a display screen of the liquid crystal display 1, a stereoscopic picture is viewable. In other words, the viewer 8 is allowed to watch the left-eye picture with his left eye 8L and the right-eye picture with his right eye 8R, and the left-eye picture and the right-eye picture have a parallax therebetween; therefore, the viewer 8 perceives the right-eye picture and the left-eye picture as a stereoscopic picture with a depth.

### 2. Partial Light Emission Operation Suitable for Stereoscopic Picture

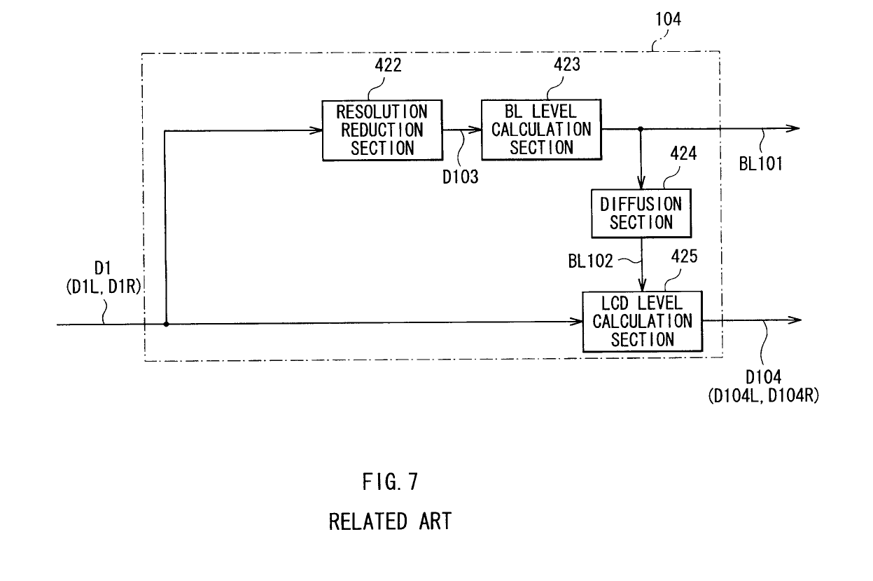

Next, referring to FIGS. 7 to 11, as one of characteristic parts of the invention, the divisional light emission operation of the backlight 3 suitable for stereoscopic picture display will be described in detail below in comparison with a comparative example.

### 2-1. Comparative Example

FIG. 7 illustrates a block diagram of a divisional-drive processing section (a divisional-drive processing section 104) in a liquid crystal display according to a comparative example. The divisional-drive processing section 104 in the comparative example has the same configuration as that of the divisional-drive processing section 42 in the embodiment illustrated in FIG. 4, except that the logical-OR picture generation section 421 is removed (not arranged). In other words, the comparative example corresponds to the case where a divisional light emission operation in a backlight in related art is applied as-is to a time division drive stereoscopic picture display system.

Therefore, in the divisional-drive processing section 104, first, the resolution reduction section 422 performs a resolution reduction process on the picture signal D1 (D1L, D1R) to generate a picture signal D103. Next, the BL level calculation section 423 generates a light emission pattern signal BL101 representing a light emission pattern for each of the light emission sub-regions 36 based on the picture signal D103. Moreover, the diffusion section 424 performs a diffusion process on the light emission pattern signal BL101 supplied from the BL level calculation section 423 to output the light emission pattern signal BL102 subjected to the diffusion process to the LCD level calculation section 425. Then, the LCD level calculation section 425 generates a divisional-drive picture signal D104 configured by alternately arranging a left-eye picture signal D104L and a right-eye picture signal D104R in one frame period based on the picture signal D1 (D1L, D1R) and the light emission pattern signal BL102 subjected to the diffusion process. More specifically, as in the case of the embodiment, the LCD level calculation section 425 generates a left-eye picture signal D104L and a right-eye picture signal D104R with use of the following expressions (3) and (4).

D104L=(D1L/BL102) (3)

D104R=(D1R/BL102) (4)

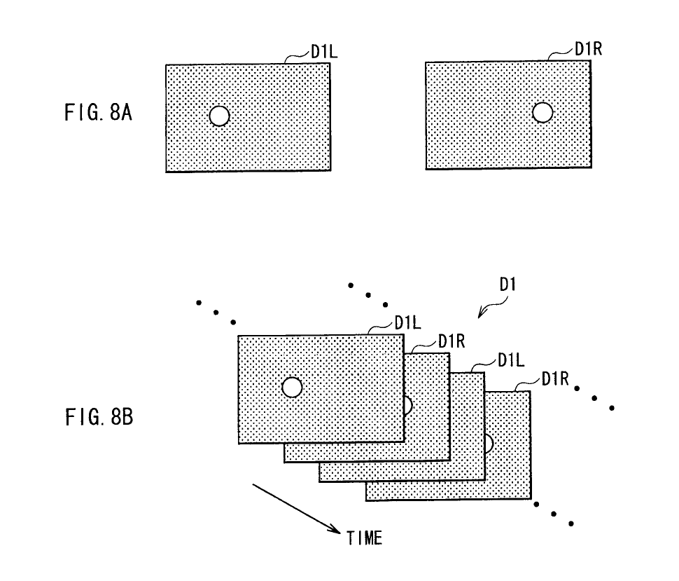

The case where in the picture signal D1 entered into the divisional-drive processing section 104, the left-eye picture signal D1L and the right-eye picture signal D1R alternately arranged along a temporal axis represent, for example, pictures illustrated in FIGS. 8A and 8B, respectively, will be considered below. In other words, still pictures in which a small bright object is present in a dark (gray-level) background as a whole will be considered. In this case, the left-eye picture signal D1L and the right-eye picture signal D1R have a parallax therebetween, so the position of the small bright object varies between the pictures.

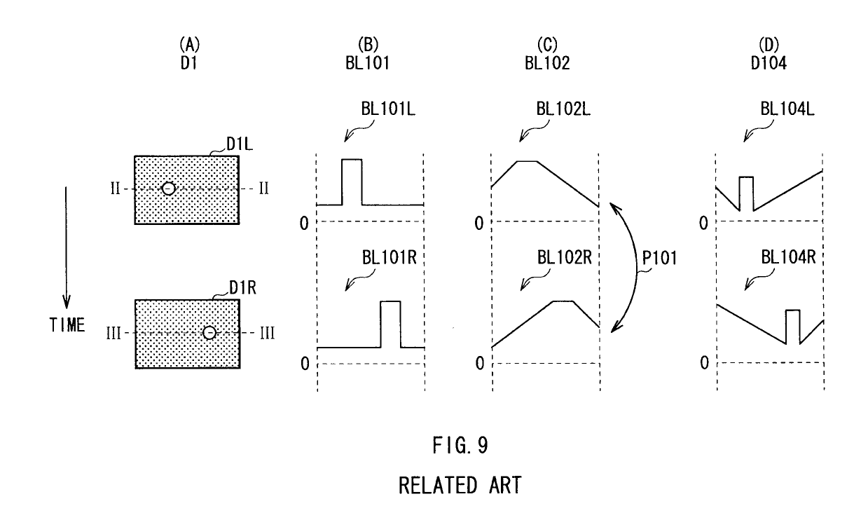

FIG. 9 illustrates a divisional light emission operation in the liquid crystal display in the comparative example with a timing chart. In FIG. 9, parts (A), (B), (C) and (D) illustrate signals for right and left eyes configuring the picture signal D1, the light emission pattern signal BL101, the light emission pattern signal BL102 and the divisional-drive picture signal D104, respectively. Note that in the parts (B) to (D), a horizontal axis indicates a pixel position in a horizontal direction along a line II-II or a line III-III in the part (A). Moreover, in the part (A), a vertical axis indicates a pixel position in a vertical direction of a screen, and in the parts (B) to (D), the vertical axis indicates a level axis.

In the comparative example, left and right light emission pattern signals (the light emission pattern signals BL101L and BL101R) are generated based on the left-eye picture signal D1L and the right-eye picture signal D1R illustrated in the part (A) in FIG. 9 (refer to the part (B) in FIG. 9). Moreover, based on the left and right light emission pattern signals BL101L and BL101R, left and right light emission pattern signals BL102L and BL102R subjected to the diffusion process are generated, and left and right divisional-drive picture signals D104L and D104R are generated (refer to the parts (C) and (D) in FIG. 9). Then, the divisional light emission operation and the display operation are performed based on the left and right light emission pattern signals BL and BL and the left and right divisional-drive picture signals D104L and D104R.

At this time, as described above, the position of the object differs between the left and right pictures, so in an actual light emission pattern of the backlight 3, the position of the object differs between when the left-eye picture is displayed and when the right-eye picture is displayed (refer to a reference numeral P101 in the part (C) in FIG. 9). More specifically, a light emission sub-region 36 where light emission intensity differs between when the left picture is displayed and when the right picture is displayed exists, and in extreme cases, the light emission sub-region 36 may emit light when one of the pictures is displayed and may not emit light when the other picture is displayed.

When a change (a temporal change) in light emission luminance in the light emission sub-region 36 between the left and right pictures occurs, the change also greatly affects a region which has no parallax and is supposed to have constant light emission luminance; therefore, it is difficult to solve such an issue by control of transmittance in the liquid crystal display panel 2. As a result, like the comparative example, in the case where a divisional light emission operation of a backlight in related art is applied as-is to the time division drive stereoscopic picture display system, the generation of flickers is increased to cause a decline in display image quality.

Moreover, to prevent a temporal change in light emission luminance between left and right pictures, for example, it is considered to arrange a filter in a temporal axis direction; however, the following issue arises. When light emission luminance is leveled out with use of the filter, the light emission luminance is set to an intermediate light emission level between the left and right pictures when the left picture is displayed and when the right picture is displayed, so compared to an original level, the light emission luminance is reduced (a picture becomes dark or a defect in white gradation occurs), and it is difficult to secure display luminance.

### 2-2. Embodiment

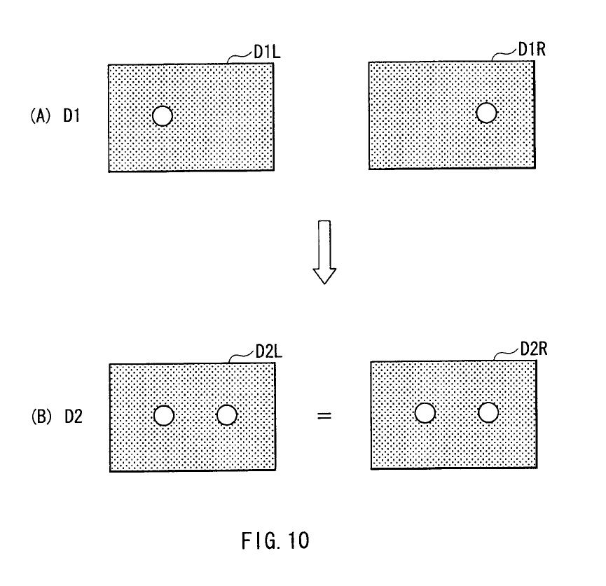

On the other hand, in the embodiment, the logical-OR picture generation section 421 in the divisional-drive processing section 42 generates a logical-OR picture which is a logical-OR of the left-eye picture and the right-eye picture based on the picture signal D1 configured by alternately arranging the left-eye picture signal D1L and the right-eye picture signal D1R. More specifically, for example, as illustrated in parts (A) and (B) in FIG. 10, the logical-OR of the left-eye picture signal D1L and the right-eye picture signal D1R is determined in each pixel 20 to generate the picture signal D2 configuring such a logical-OR picture. Then, the generated picture signal D2 is configured by alternately arranging the left-eye picture signal D2L and the right-eye picture signal D2R which are the same picture signals in one frame period. The divisional light emission operation in the embodiment using such a logical-OR picture (the picture signal D2) will be described in detail below.

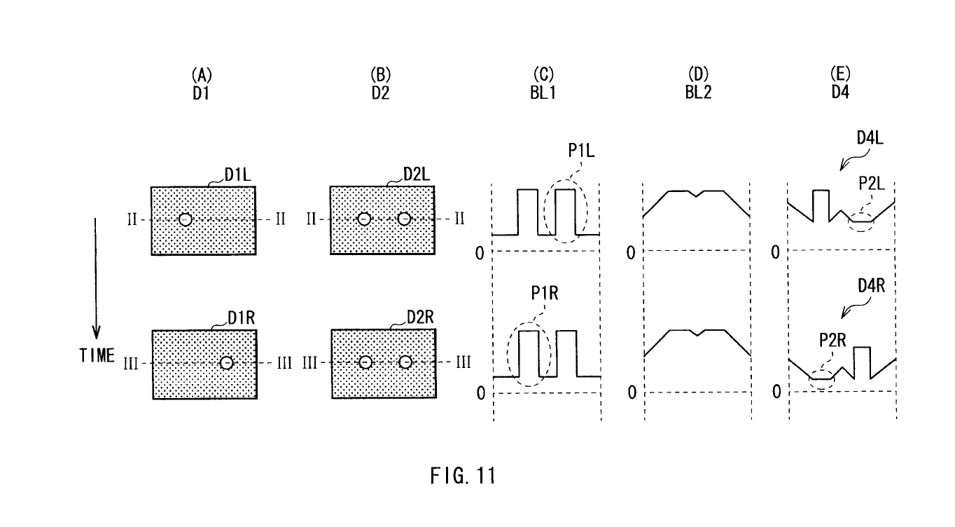

FIG. 11 schematically illustrates the divisional light emission operation in the liquid crystal display 1 according to the embodiment, in the case where the picture signal D1 (D1L and D1R) illustrated in FIG. 8 is entered, with a timing chart. In FIG. 11, parts (A), (B), (C), (D) and (E) indicate signals for left eye and right eye configuring the picture signal D1, the picture signal D2, the light emission pattern signal BL1, the light emission pattern signal BL2 and the divisional-drive picture signal D4, respectively. Note that in the parts (C) to (E), a horizontal axis indicates a pixel position in a horizontal direction along a line II-II or a line III-III in the parts (A) and (B). Moreover, in the parts (A) and (B), a vertical axis indicates a pixel position in a vertical direction in a screen, and in the parts (C) to (E), the vertical axis indicates a level axis.

As illustrated in the parts (A) and (B) in FIG. 11, in the embodiment, as described above, the logical-OR picture generation section 421 generates the picture signal D2 (D2L, D2R) configuring a logical-OR picture based on the left-eye picture signal D1L and the right-eye picture signal D1R. Then, the BL level calculation section 423 generates the common light emission pattern signal BL1 to the left and right signals with use of the picture signal D3 based on the logical-OR picture signal D2 to the left and right signals (refer to the part (C) in FIG. 11).

Moreover, the diffusion section 424 generates the common light emission pattern signal BL2 to the left and right signals subjected to the diffusion process with use of the common light emission pattern signal BL1 to the left and right signals, and the LCD level calculation section 425 generates left and right divisional-drive picture signals D4L and D4R (refer to the parts (D) and (E) in FIG. 11). Then, the divisional light emission operation and the display operation are performed based on the light emission pattern signal BL1 and the divisional-drive picture signal D4 (D4L and D4R).

Therefore, in the embodiment, unlike the above-described comparative example in which the divisional light emission operation and the display operation are performed with use of the light emission pattern signals BL101L and BL101R generated corresponding to the left and right pictures which are different from each other, respectively, a change (a temporal change) in light emission luminance (display luminance) between the left and right pictures is prevented (refer to the parts (C) and (D) in FIG. 11). As a result, compared to the comparative example, the generation of flickers is allowed to be reduced in the embodiment.

Moreover, as the logical-OR picture is determined as a logical-OR of the left and right pictures in each pixel 20, for example, unlike the case where a filter for leveling out the light emission pattern signal and the divisional-drive picture signal along a temporal axis direction is used, display luminance does not decline.

At this time, as indicated by reference numerals P1L and P1R in the part (C) in FIG. 11, even in a dark pixel region in each of the original picture signals D1L and D1R, a light emission pattern corresponding to a bright part is arranged. However, as indicated by reference numerals P2L and P2R in the part (E) in FIG. 11, transmittance in the pixel region is reduced in the liquid crystal display panel 2 to set actual display luminance to a correct value.

As described above, in the embodiment, the logical-OR picture (the picture signal D2) as a logical-OR picture of left and right pictures is generated by determining a logical-OR of the left and right pictures in each pixel 20 based on the input picture signal Din, and the light emission pattern signal BL1 and the divisional-drive picture signal D4 are generated with use of the logical-OR picture; therefore, without reducing display luminance (while maintaining display luminance), a temporal change in display luminance between the left and right pictures is preventable to thereby reduce the generation of flickers. Therefore, when a plurality of pictures are displayed through performing time-divisional switching of a plurality of picture streams from one to another in order with use of the light source performing the divisional light emission operation, display image quality is allowed to be improved. Further, when the divisional light emission operation is performed, as in the case of the divisional light emission operation in related art, a reduction in power consumption and an improvement in black luminance are achievable.

### Modifications

Next, modifications (Modifications 1 and 2) of the above-described embodiment will be described below. Note that like components are denoted by like numerals as of the above-described embodiment and will not be further described.

### Modification 1

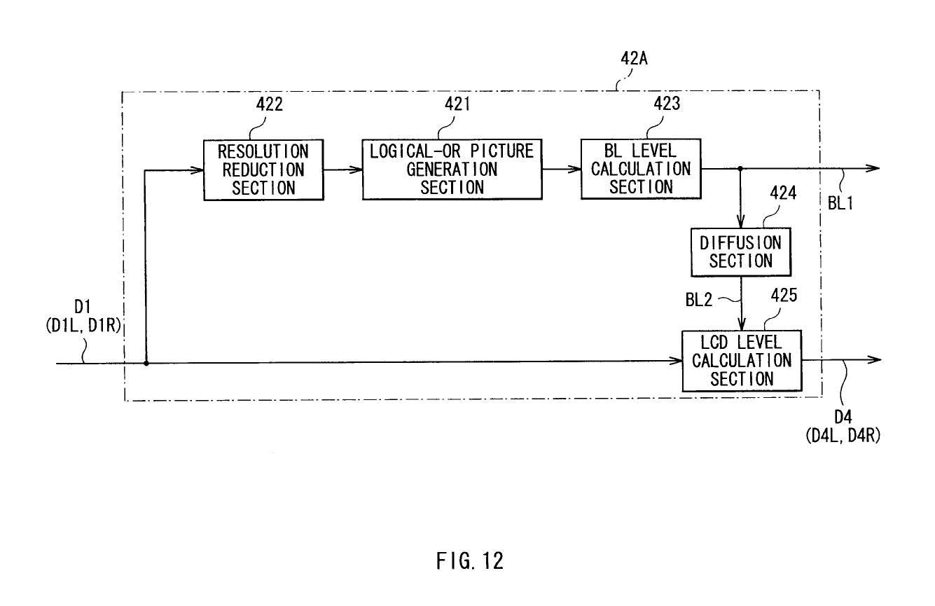

FIG. 12 illustrates a block diagram of a divisional-drive processing section (a divisional-drive processing section 42A) in a picture display system (a liquid crystal display) according to Modification 1. The divisional-drive processing section 42A in the modification corresponds to a divisional-drive processing section in which the arrangement order of the logical-OR picture generation section 421 and the resolution reduction section 422 is opposite to that in the divisional-drive processing section 42 in the embodiment illustrated in FIG. 4.

In other words, in the divisional-drive processing section 42A, first, the resolution reduction section 422 performs the predetermined resolution reduction process which is described in the above-described embodiment on the picture signal D1 (D1L and D1R). Next, as in the case of the above-described embodiment, the logical-OR picture generation section 421 generates a logical-OR picture as a logical-OR of the left-eye picture and the right-eye picture based on a resolution-reduced logical-OR picture signal which is resultant of the resolution reduction process. However, in the modification, the logical-OR of the left-eye picture signal and the right-eye picture signal is determined in each unit region subjected to the resolution reduction process (more specifically, in each light emission sub-region 36) to generate such a logical-OR picture.

Even in the picture display system (the liquid crystal display) using the divisional-drive processing section 42A with such a configuration, the same effects as those in the above-described embodiment are obtainable.

### Modification 2

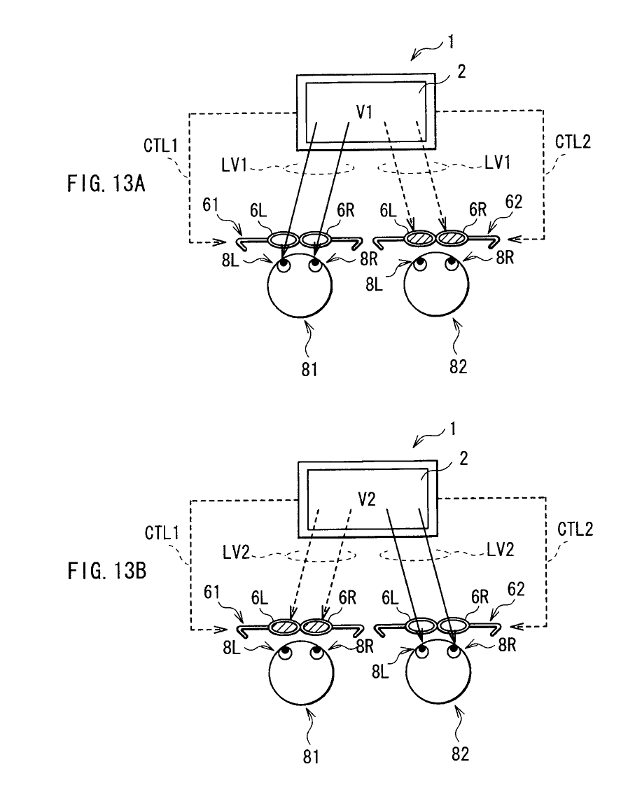

FIG. 13 schematically illustrates a picture display operation in a picture display system (a multi-view system) according to Modification 2. In the modification, instead of the above-described stereoscopic picture display operation, a multiple picture display operation allowing a plurality of viewers (in this case, two viewers) to watch a plurality of (in this case, two) pictures, respectively, which are different from each other is performed. Note that like components are denoted by like numerals as of the above-described embodiment and will not be further described.

In the multi-view system in the modification, a first picture based on a first picture signal corresponding to a first viewer and a second picture based on a second pictures signal corresponding to a second viewer are displayed through performing time-divisional switching of a left-eye picture stream and a right-eye picture stream. In other words, in the embodiment, the left-eye picture and the right-eye picture are displayed for the left-eye lens 6L and the right-eye lens 6R in the shutter glasses 6, respectively, but in the modification, a plurality of pictures corresponding to respective viewers (users) are displayed.

More specifically, as illustrated in FIG. 13A, in a displaying period of a first picture V1, in shutter glasses 61 used by a viewer 81, both of the right-eye lens 6R and the left-eye lens 6L are turned into an open state in response to a control signal CTL1. Moreover, in shutter glasses 62 used by a viewer 82, both of the right-eye lens 6R and the left-eye lens 6L are turned into a close state in response to a control signal CTL2. In other words, the shutter glasses 61 used by the viewer 81 allow display light LV1 based on the first picture V1 to pass therethrough, and the shutter glasses 62 used by the viewer 82 shield the display light LV1.

On the other hand, as illustrated in FIG. 13B, in a displaying period of a second picture V2, in the shutter glasses 62 used by the viewer 82, both of the right-eye lens 6R and the left-eye lens 6L are turned into an open state in response to the control signal CTL2. Moreover, in the shutter glasses 61 used by the viewer 81, both of the right-eye lens 6R and the left-eye lens 6L are turned into a close state in response to the control signal CTL1. In other words, the shutter glasses 62 used by the viewer 82 allow display light LV2 based on the second picture V2 to pass therethrough, and the shutter glasses 61 used by the viewer 81 shield the display light LV2.

Then, when the states illustrated in FIGS. 13A and 13B are alternately repeated in a time-divisional manner, two viewers 81 and 82 are allowed to watch different pictures (the pictures V1 and V2), respectively (a multi-view mode is achieved).

Also, in the case where a multiple picture display operation is performed as in the case of the modification, when the divisional light emission operation (a divisional-drive operation) described in the above-described embodiment and the above-described Modification 1 is performed, the same effects as those in the above-described embodiment and the like are obtainable.

Note that in the modification, the case where two viewers watch two different pictures, respectively is described; however, the invention is applicable to the case where three or more viewers watch three or more different pictures, respectively. Moreover, the number of pictures and the number of pairs of shutter glasses are not necessarily equal to each other. In other words, a plurality of pairs of shutter glasses performing an opening/closing operation corresponding to one picture may be prepared, and a plurality of viewers may watch the one picture.

### Other Modifications

Although the present invention is described referring to the embodiment and the modifications, the invention is not limited thereto, and may be variously modified.

For example, in the above-described embodiment and the like, the case where the backlight includes the red LED, the green LED and the blue LED as light sources is described. However, in addition to them (or instead of them), the backlight may include a light source emitting light of another color. For example, in the case where the backlight is configured of light sources of four or more colors, a color reproduction range is expanded, and more various colors are allowed to be reproduced.

Moreover, for example, the shutter glasses may support both of the stereoscopic picture display system and the multi-view system described in the embodiments and the modifications by switching modes.

In addition, the processes described in the above-described embodiment and the like may be performed by hardware or software. In the case where the processes are performed by software, a program forming the software is installed in a general-purpose computer or the like. Such a program may be stored in a recording medium mounted in the computer in advance.

The present application contains subject matter related to that disclosed in Japanese Priority Patent Application JP 2010-051979 filed in the Japan Patent Office on Mar. 9, 2010, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A liquid crystal display comprising:
a light source section including a plurality of light emission subsections which are controlled separately from one another;
a liquid crystal display panel modulating, based on an input picture signal, light emitted from each of the light emission subsections of the light source section to display pictures through performing time-divisional switching of a plurality of picture streams from one to another in order; and
a display control section including a divisional-drive processing section which generates a light emission pattern signal and a divisional-drive picture signal based on the input picture signal, the light emission pattern signal representing a light emission pattern for each of the light emission subsections of the light source section, the display control section performing a light emission drive on each of the light emission subsections of the light source section with use of the light emission pattern signal and performing a display drive on the liquid crystal display panel with use of the divisional-drive picture signal,
wherein the divisional-drive processing section determines, based on the input picture signal, a logical-OR picture which is a logical-OR of pictures each belonging to the plurality of picture streams, and generates the light emission pattern signal and the divisional-drive picture signal with use of the logical-OR picture.

2. The liquid crystal display according to claim 1, wherein
the divisional-drive processing section includes:
a logical-OR picture generation section generating the logical-OR picture based on the input picture signal, and
a resolution reduction section performing a predetermined resolution reduction process on the logical-OR picture, and
the divisional-drive processing section generates the light emission pattern signal and the divisional-drive picture signal with use of a resolution-reduced logical-OR picture which is resultant of the resolution reduction process.

3. The liquid crystal display according to claim 1, wherein
the plurality of picture streams includes a left-eye picture stream and a right-eye picture stream having a parallax therebetween.

4. A picture display system including a liquid crystal display and shutter glasses, the shutter glasses performing an opening/closing operation in synchronization with switching of the plurality of pictures in the liquid crystal display, the liquid crystal display comprising:
a light source section including a plurality of light emission subsections which are controlled separately from one another;
a liquid crystal display panel modulating, based on an input picture signal, light emitted from each of the light emission subsections of the light source section to display pictures through performing time-divisional switching of a plurality of picture streams from one to another in order; and
a display control section including a divisional-drive processing section which generates a light emission pattern signal and a divisional-drive picture signal based on the input picture signal, the light emission pattern signal representing a light emission pattern for each of the light emission subsections of the light source section, the display control section performing a light emission drive on each of the light emission subsections of the light source section with use of the light emission pattern signal and performing a display drive on the liquid crystal display panel with use of the divisional-drive picture signal,
wherein the divisional-drive processing section determines, based on the input picture signal, a logical-OR picture which is a logical-OR of pictures each belonging to the plurality of picture streams, and generates the light emission pattern signal and the divisional-drive picture signal with use of the logical-OR picture.

5. The picture display system according to claim 4, wherein
the plurality of picture streams include a left-eye picture stream and a right-eye picture stream having a parallax therebetween.
